(19) United States
(12) Patent Application Publication
(10) Pub. No.: US 2026/0147293 A1
(43) Pub. Date: May 28, 2026

(54) FIXING DEVICE

(71) Applicant: Sharp Kabushiki Kaisha, Sakai City (JP)

(72) Inventor: Kan MUKAI, Sakai City (JP)

(21) Appl. No.: 19/372,435

(22) Filed: Oct. 29, 2025

(30) Foreign Application Priority Data
Nov. 27, 2024 (JP) 2024-206218

(51) Int. Cl. G03G 15/20; G03G 15/00

(52) U.S. Cl. CPC G03G 15/2032; G03G 15/2064; G03G 15/5075; G03G 15/55; G03G 15/657; G03G 15/6573; G03G 2215/00721; G03G 2215/2035

(57) ABSTRACT

A fixing device determines a slip of a fixing belt based on two or more combinations of a plurality of determination criteria including a drive current that fluctuates according to a load that rotates a fixing member, a temperature gradient of the rotation of the fixing member, and a time difference between detection of a sheet (not illustrated) by a pre-fixing sensor and detection of the sheet by a post-fixing sensor.

### CROSS REFERENCE TO RELATED APPLICATION

The present application claims priority from Japanese Application JP2024-206218, the content of which is hereby incorporated by reference into this application.

### BACKGROUND OF THE INVENTION

### 1. Field of the Invention

The disclosure relates to a fixing device.

### 2. Description of the Related Art

In the related art, in a fixing device, when slidability of an inner surface of a fixing belt is deteriorated due to the service life, a belt slip of the fixing belt may occur at the time of activation after the fixing device is left for a long time, in a low temperature environment, or the like. When the belt slip occurs, the fixing belt is heated and the belt is damaged, and therefore needs to be immediately stopped. In a case where the fixing device is stopped after waiting for a high-temperature trouble to be detected, the belt damage is large, and therefore, it is necessary to detect the belt slip before the belt damage. An image forming apparatus including a fixing device that detects such a slip of a fixing belt determines whether a slip of the fixing belt occurs or not by detecting a temperature difference between a drive transmission surface portion and a sheet passing surface portion.

### SUMMARY OF THE INVENTION

The fixing device in the related art that detects a slip of the fixing belt was configured as described above. In the fixing device in the related art, a slip of the fixing belt was determined only by a temperature difference between the drive transmission surface portion and the sheet passing surface portion, and therefore, there was a problem that it was unclear whether a slip of the fixing belt was reliably generated or not.

The disclosure has been made to solve the above problem, and an object of the disclosure is to provide a fixing device capable of detecting a slip of a fixing belt before the fixing belt is damaged.

A fixing device according to the disclosure includes a tubular fixing belt including a heater and a nip forming portion inside, a pressing member that abuts against an outer periphery of the fixing belt to form a nip so as to pinch the fixing belt between the pressing member and the nip forming portion, and rotates to cause the fixing belt to follow, a drive device that rotates the pressing member, a pre-fixing sensor that detects a sheet upstream of the nip in a sheet transport direction, and a post-fixing sensor that detects the sheet downstream of the nip in the sheet transport direction, wherein the drive device determines a slip of the fixing belt based on two or more combinations of a plurality of determination criteria including a drive current that fluctuates according to a load that rotates the fixing belt, a temperature gradient in a case where the fixing belt is rotated while being heated, and a time difference between detection of the sheet by the pre-fixing sensor and detection of the sheet by the post-fixing sensor.

The determination of a slip of the fixing belt may be performed while the sheet is passing during job execution or may be performed while the sheet is not passing after job execution.

A pressing mechanism that presses the fixing belt may be provided, and the pressing mechanism may enable switching among a pressing state, a pressure released state, and an intermediate state between the pressing state and the pressure released state, and may have determination criteria that determines a slip of the fixing belt in the respective states.

In another aspect of the disclosure, an image forming apparatus may include the fixing device described above, and may restrict image formation according to a determination that a slip of the fixing belt is present, or may include a notifier, and may externally notify according to the determination that the slip of the fixing belt is present.

According to the disclosure, since a slip of the fixing belt is determined based on the two or more combinations among the plurality of determination criteria, it is possible to provide a fixing device capable of detecting a slip of a fixing belt before the fixing belt is damaged.

The above-described objects, other objects, features, and advantages of the disclosure will be further obvious from the detailed description of examples given below with reference to the drawings.

### BRIEF DESCRIPTION OF THE DRAWINGS

FIG. 1 is a diagram illustrating a nip portion of a fixing device according to an embodiment of the disclosure, and is a diagram illustrating a pressure released state and a pressing state.

FIG. 2 is a graph showing a fluctuation in current value of a fixing motor (not illustrated) that rotates a fixing belt converted into torque.

FIG. 3 includes graphs showing the presence or absence of a temperature gradient abnormality at a fixed time interval.

FIG. 4 is a diagram showing graphs for detecting a suspicion of a sheet transport delay.

### DETAILED DESCRIPTION OF THE INVENTION

### First Embodiment

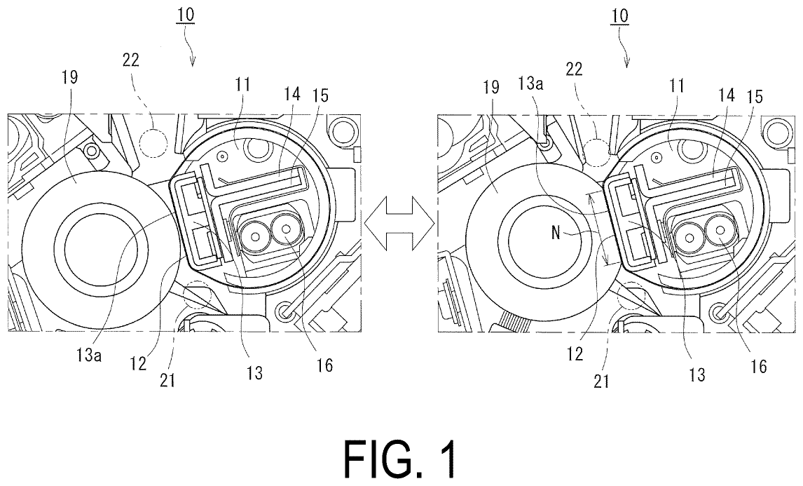

An embodiment according to the disclosure will be described in detail below with reference to the drawings. FIG. 1 is a diagram illustrating a nip portion N of a fixing device according to the embodiment of the disclosure. In the disclosure, the fixing device includes a pressing mechanism (not illustrated) that presses a fixing belt, and the pressing mechanism enables switching among a pressing state, a pressure released state, and an intermediate state between the pressing state and the pressure released state.

A left side of FIG. 1 illustrates the pressure released state in which a minimum load is applied, and a right side illustrates the pressing state in which a maximum load is applied. In the disclosure, from the pressure released state in which the minimum load is applied as illustrated on the left side to the pressing state in which the maximum load is applied as illustrated on the right side, the application is fixed at any load position to detect a slip of the fixing belt.

First, referring to a diagram of the pressure released state on the left side of FIG. 1, a fixing device 10 includes a fixing member 11 which is a cylindrical portion disposed on the right side in the diagram, and a pressing member 19 which is a cylindrical portion disposed on the left side in the drawing. The fixing member 11 includes a fixing belt 12 provided at an outer periphery of the fixing member 11, an abutting member 13 provided inside the fixing belt 12, an inverted L-shaped sheet metal 14 and an L-shaped sheet metal 15 provided adjacent to each other on a side of the abutting member 13 opposite to the fixing belt 12, and a heater 16 provided adjacent to the L-shaped sheet metal 15.

The pressing member 19 abuts against a flat portion 13a of the abutting member 13 to form the nip portion N indicated by an arrow in the diagram, and a sheet (not illustrated) is transported from below in an upper direction to the nip portion N to perform a fixing operation. In the disclosure, the pressing member 19 receives a driving force from a fixing motor (not illustrated) to rotate, and causes the fixing belt 12 to be driven via the nip portion N. A pre-fixing sensor 21 and a post-fixing sensor 22 are provided at positions forward and rearward the nip portion N in a sheet transport direction, respectively, and detect a suspicion of a sheet transport delay described below.

Here, because of the pressure released state, a dimension of a contact portion of the pressing member 19 with the flat portion 13a of the abutting member 13 is short.

On the other hand, a diagram on the right side of FIG. 1 illustrates the state in which the fixing device 10 is pressed with the maximum load. Here, the same reference numerals as those in the left drawing of FIG. 1 are given to portions corresponding to those in the left drawing, and the description thereof will be omitted. Referring to the drawing on the right side of FIG. 1, a length of the nip portion Nis larger than that in the drawing on the left side of FIG. 1.

In the embodiment, it is determined whether a cause of a slip of the fixing belt 12 or not from a measurement result of each of the three states of the left side (pressure released state), the right side (state of being pressed with the maximum load), and a load in between.

Next, determination criteria for determining whether a cause of a slip of the fixing belt 12 or not will be described.

In the disclosure, three determination criteria A to C are present for determining whether a cause of a slip of the fixing belt 12 or not, and the fixing belt 12 is determined using any two of the criteria. First, a first (determination A) will be described.

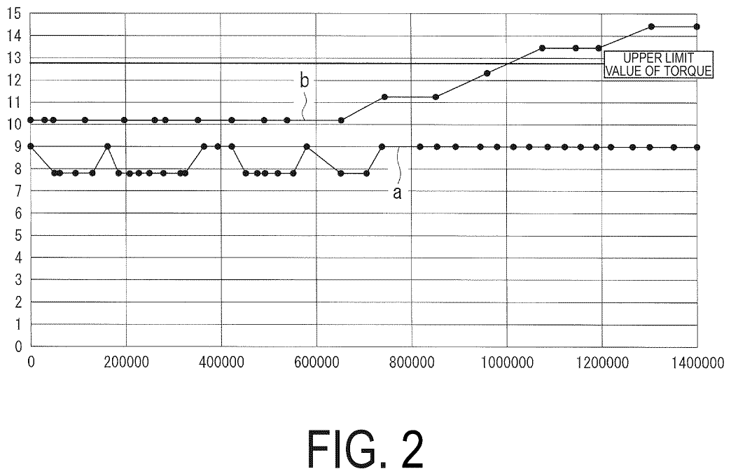

The first determines using a current value (torque) of the fixing motor (not illustrated) that rotates the fixing belt 12. FIG. 2 is a graph showing a fluctuation in current value of the fixing motor (not illustrated) that rotates the fixing belt 12 converted into torque. In the drawing, an X-axis represents time and a Y-axis represents torque. As shown in FIG. 2, an upper limit value of the torque is determined in advance. At a normal time, the fixing belt 12 follows rotation of the pressing member 19 that receives a driving force from the fixing motor (not illustrated), and therefore, as indicated by “a” in the diagram, the value of the torque does not exceed the upper limit value even after a lapse of time.

On the other hand, at an abnormal time, the fixing belt 12 is brought into a state of being unlikely to follow, and thus a load larger than usual is applied to the pressing member 19 that receives a driving force from the fixing motor (not illustrated). As the fixing belt 12 becomes further unlikely to follow, the load increases, and the torque exceeds the predetermined upper limit value of the torque as indicated by “b” in FIG. 1.

Therefore, when the current value of the fixing motor fluctuates as indicated by “b” in the graph shown in FIG. 2, it is determined that the fixing belt 12 is slipping.

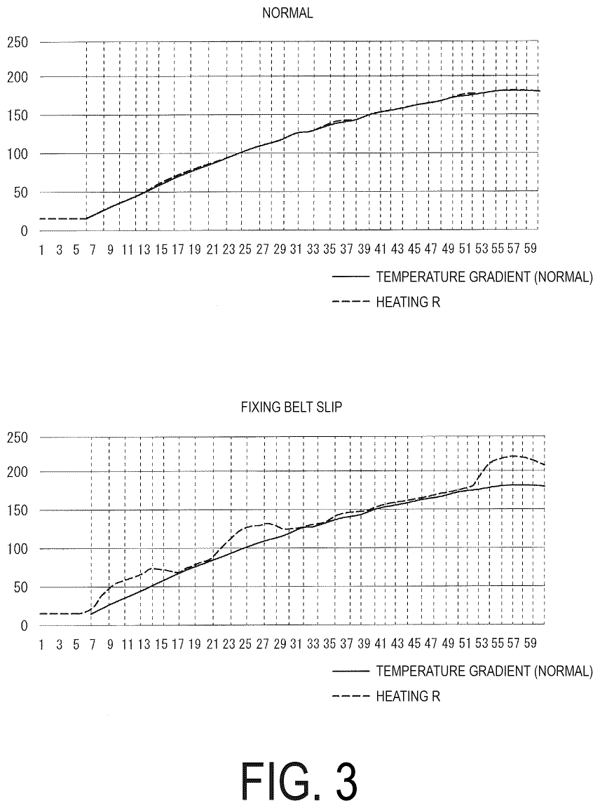

A second (determination B) determines presence or absence of a temperature gradient abnormality at a fixed time interval. FIG. 3 includes graphs showing the presence or absence of a temperature gradient abnormality at a fixed time interval. In the diagram, two graphs showing temperature gradients are shown in a vertical direction. In the graph, an X-axis represents time, and a Y-axis represents temperature of the fixing belt 12. The temperature of the fixing belt 12 is measured by a thermometer (not illustrated) provided in the vicinity of the fixing belt 12.

A graph showing a normal temperature gradient is illustrated on an upper side. As shown in the graph, the normal temperature gradient (a solid line) and heating R of the fixing belt 12 (a dotted line) overlap each other here. That is, the temperature of the fixing belt 12 rises continuously according to a lapse of time.

In addition to the graph showing the normal temperature gradient shown in the upper side, a graph showing a case where a slip of the fixing belt 12 occurs is shown on a lower side. As shown in the graph, the heating R (dotted line) of the fixing belt 12 does not rise continuously according to a lapse time, but rises irregularly.

Therefore, in the graphs shown in FIG. 3, when the temperature gradient shown on the lower side does not rise continuously according to a lapse of time but rises irregularly, it is determined that the fixing belt 12 is slipping.

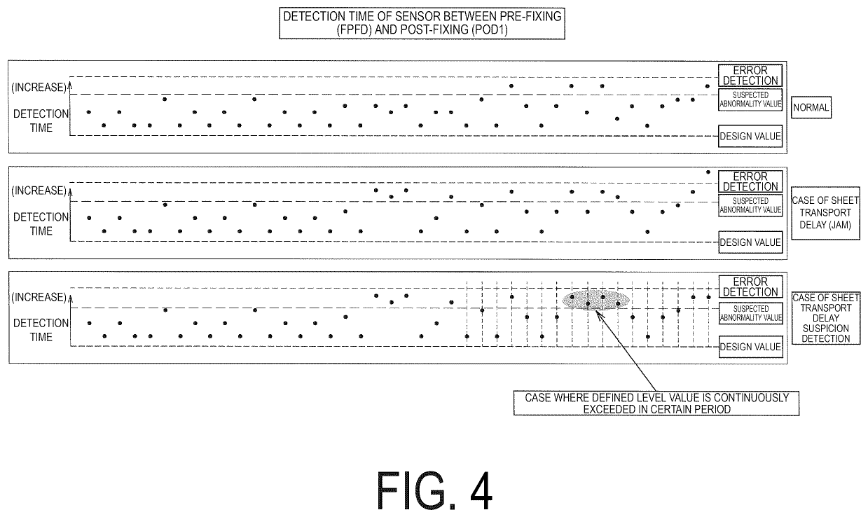

Next, a third (determination C) will be described. The third determines a slip of the fixing belt 12 by detecting a suspicion of a sheet transport delay. FIG. 4 is a diagram including graphs for detecting a suspicion of a sheet transport delay. Here, three patterns of a normal case, a case of a sheet transport delay (JAM case), and a case of a sheet transport delay suspicion detection are shown in order from the top. In each graph, an X-axis represents time, and a Y-axis represents detection time. On the Y-axis, a design value, a suspected abnormality value, and a value at the time of error detection are shown.

First, the normal case at the top will be described. At this time, the detection time has a value that is basically lower than the suspected abnormality value, and sometimes exceeds the suspected abnormality value, but does not exceed the error detection value.

Next, the case of the sheet delay (JAM case) will be described. Referring to the case of a sheet delay (JAM case), the detection time has a value that is basically lower than the suspected abnormality value, sometimes exceeds the suspected abnormality value, and may exceed the error detection value. This case where the error detection value is exceeded is the case of a sheet delayed (JAM case).

Next, a case of the sheet transport delay suspicion detection will be described. Referring to the case of sheet transport delay suspicion detection, the detection time has a value that is basically lower than the suspected abnormality value and sometimes exceeds the suspected abnormality value, and in a range within which the error detection value is not exceeded, the detection time may continuously exceed a defined level value in a certain period as shown so as to be surrounded by an elliptical dotted line in the drawing. When such a value is detected, it is determined that the sheet transport delay suspicion has been detected.

Therefore, in the graphs shown in FIG. 4, when it is detected that the defined level value is continuously exceeded in a certain period within a range within which the error detection value is not exceeded as shown at the bottom, it is determined that the fixing belt 12 is slipping.

### Second Embodiment

Note that the above slip determinations of the fixing belt 12 may be performed while the sheet is passing during job execution, may be performed while the sheet is not passing after the job is completed, or as described above, the pressing mechanism (not illustrated) that presses the fixing member 11 may be provided, and the pressing mechanism may enable switching among the pressing state, the pressure released state, and the intermediate state between the pressing state and the pressure released state and have determination criteria that determines a slip in the respective states.

The above contents are shown in the following tables. Table 1 shows determination timing. The determination is performed in a case without sheet passing, such as after a JOB is completed or in a test mode, or in a case with sheet passing during sheet passing.

The determination is performed according to the three determinations A to C described above.

TABLE 1

| | | | |
|---|---|---|---|
| Determination | Case | After JOB is completed, | Results of |
| timing | without | test mode | A/B/C are |
| | sheet | | collectively |
| | passing | | determined |
| | Case with | While the sheet is passing | |
| | sheet | | |
| | passing | | |

Next, a relationship between determination items and pressing states will be described. Table 2 is a table showing the relationship between the determination items and the pressing states, and also shows whether a sheet passes or not for each of the pressing states.

TABLE 2

| | | Pressure released | | | | | |
|---|---|---|---|---|---|---|---|
| | | state | | Intermediate | | Pressing state | |
| | | Case | Case | Case | Case | Case | Case |
| | | without | with | without | with | without | with |
| | | sheet | sheet | sheet | sheet | sheet | sheet |
| Determination items | | passing | passing | passing | passing | passing | passing |
| A | Current value (torque) | Yes | Yes | Yes | Yes | Yes | Yes |
| B | Temperature gradient | Yes | Yes | Yes | Yes | Yes | Yes |
| | abnormality | | | | | | |
| C | Sheet transport delay | Not | Yes | Not | Yes | Not | Yes |
| | suspicion detection | applicable | | applicable | | applicable | |

Referring to Table 2, A and B are determined in the case without sheet passing and in the case with sheet passing regardless of the pressing state, but C is determined only in the case with sheet passing in each of the pressing states.

Next, how a determination of presence or absence of s slip is made from the determination results of A to C in the case without sheet passing and in the case with sheet passing will be described. Table 3 is a table showing how the determination of the presence or absence of a slip is made from the determination results of A to C.

Referring to Table 3, in A, “OK” indicates that a current value of the fixing motor is normal, and “NOT ACCEPTABLE” indicates that the current value of the fixing motor is abnormal. In addition, in B, “OK” indicates that a temperature gradient in a fixed time interval is normal, and “NOT ACCEPTABLE” indicates that the fixing belt 12 is slipping. In addition, in C, “OK” indicates that sheet transport delay suspicion is absent, and “NOT ACCEPTABLE” indicates that sheet transport delay suspicion is detected.

TABLE 3

| | | Case without sheet passing | | | | Case with sheet passing | | | | | | |
|---|---|---|---|---|---|---|---|---|---|---|---|---|
| A | OK | OK | OK | NOT | NOT | OK | OK | NOT | NOT | OK | NOT | NOT |
| | | | | ACCEPT- | ACCEPT- | | | ACCEPT- | ACCEPT- | | ACCEPT- | ACCEPT- |
| | | | | ABLE | ABLE | | | ABLE | ABLE | | ABLE | ABLE |
| B | OK | OK | NOT | NOT | OK | OK | NOT | NOT | OK | NOT | NOT | OK |
| | | | ACCEPT- | ACCEPT- | | | ACCEPT- | ACCEPT- | | ACCEPT- | ACCEPT- | |
| | | | ABLE | ABLE | | | ABLE | ABLE | | ABLE | ABLE | |
| C | Not | Not | Not | Not | Not | NOT | NOT | NOT | OK | OK | OK | NOT |
| | applic- | applic- | applic- | applic- | applic- | ACCEPT- | ACCEPT- | ACCEPT- | | | | ACCEPT- |
| | able | able | able | able | able | ABLE | ABLE | ABLE | | | | ABLE |

| | | | | | | | | | | | |
|---|---|---|---|---|---|---|---|---|---|---|---|
| Slip determination | No | Yes | Yes | No | No | Yes | Yes | No | Yes | Yes | Yes |

The slip determination indicates a determination result of a belt slip based on respective conditions of A, B, and C. Referring to an upper left part of Table 3, when both A and B result in “OK” in the case without sheet passing, the slip determination results in NO (a slip is absent). In the case without sheet passing, when A results in “OK” and B results in “NOT ACCEPTABLE”, the slip determination results in YES (a slip is present).

Referring generally to Table 3, when both A and B result in “OK”, a slip is determined as “NO” regardless of C. When either A or B results in “NOT ACCEPTABLE”, a slip is determined as “YES” regardless of C.

Even when A results in NOT ACCEPTABLE in the case without sheet passing, as far as B results in OK, a slip is determined as “NO”.

The image forming apparatus of the disclosure may further include a notifier (not illustrated). When a slip is determined to be present, at the notifier (not illustrated), it is possible to prompt a user or an administrator to perform an early inspection or replacement of the fixing belt. As the notifier referred to herein, general notification devices or a combination thereof are conceivable, for example, a display (not illustrated) that displays a message, a light-emitter (not illustrated) that lights or blinks, or a communication device (not illustrated) that transmits information indicating presence of a slip to an external device (not illustrated).

The image forming apparatus of the disclosure may determine presence or absence of notification by the notification devices based on a cumulative number of times of the determination that a slip is present. Alternatively, the determination may be made based on presence or absence of the determination that a slip is present within a unit period. Alternatively, the determination may be made based on the determination that a slip is present after a predetermined cumulative number of sheets that pass through the fixing device. Alternatively, the determination may be made based on presence or absence of the determination that a slip is present after a predetermined period of time lapses from when the fixing device is incorporated into a main body of the image forming apparatus.

The image forming apparatus of the disclosure may be configured to restrict heating of the fixing device depending on presence or absence of the determination that a slip is present.

The disclosure may be carried out in other various forms without departing from the spirit or essential characteristics thereof. Thus, the above embodiments are merely examples and should not be interpreted as limiting. All modifications and variations that fall within the equivalent scope of the claims of the disclosure are included in the scope of the disclosure.

According to the disclosure, it is possible to detect a slip of a fixing belt before the fixing belt is damaged, and thus the disclosure is useful as a fixing device.

1. A fixing device, comprising:
a tubular fixing belt including a heater and a nip forming portion inside;
a pressing member that abuts against an outer periphery of the fixing belt to form a nip so as to pinch the fixing belt between the pressing member and the nip forming portion, and rotates to cause the fixing belt to follow;
a drive device that rotates the pressing member; and
a pre-fixing sensor that detects a sheet upstream of the nip in a sheet transport direction, and a post-fixing sensor that detects the sheet downstream of the nip in the sheet transport direction, wherein
the drive device determines a slip of the fixing belt based on two or more combinations of a plurality of determination criteria including a drive current that fluctuates according to a load that rotates the fixing belt, a temperature gradient in a case where the fixing belt is rotated while being heated, and a time difference between detection of the sheet by the pre-fixing sensor and detection of the sheet by the post-fixing sensor.

2. The fixing device according to claim 1, wherein
a slip of the fixing belt is determined while the sheet is passing during job execution.

3. The fixing device according to claim 1, wherein
a slip of the fixing belt is determined while the sheet is not passing after job execution.

4. The fixing device according to claim 1, comprising a pressing mechanism that presses the fixing belt, wherein
the pressing mechanism enables switching among a pressing state, a pressure released state, and an intermediate state between the pressing state and the pressure released state, and has a determination criterion that determines a slip of the fixing belt in each state.

5. An image forming apparatus, comprising the fixing device according to claim 1, wherein
image formation is restricted according to a determination that a slip of the fixing belt is present.

6. The image forming apparatus according to claim 5, comprising a notifier, wherein
notification is externally performed according to the determination that a slip of the fixing belt is present.
